(19) United States
(12) Patent Application Publication
(10) Pub. No.: US 2015/0109806 A1
(43) Pub. Date: Apr. 23, 2015

(54) HEAD LAMP FOR VEHICLE

(71) Applicants: HYUNDAI MOTOR COMPANY, Seoul (KR); Hyundai Mobis Co., Ltd., Seoul (KR)

(72) Inventors: Byoung Suk AHN, Suwon-si (KR); Tae Won LEE, Yongin-si (KR)

(73) Assignees: HYUNDAI MOTOR COMPANY; Hyundai Mobis Co., Ltd.

(21) Appl. No.: 14/517,274

(22) Filed: Oct. 17, 2014

(30) Foreign Application Priority Data
Oct. 17, 2013 (KR) 10-2013-0123956

(51) Int. Cl. F21S 8/10

(52) U.S. Cl. CPC F21S 48/1225; F21S 48/115; F21S 48/1317; F21S 48/125
USPC 362/510

(57) ABSTRACT

A head lamp for a vehicle includes a laser light source module. The laser light source module comprises a laser diode generating a laser beam. A phosphor is mounted in front of the laser diode to react to light from the laser diode to output white light. A short wave pass filter is coupled with the phosphor to transmit a laser beam from the laser diode to the phosphor and retro-reflect light scattered in remaining directions avoiding a light emitting surface of the phosphor among the laser beam incident on the phosphor to the phosphor.

### CROSS REFERENCE TO RELATED APPLICATION

The present application claims the benefit of priority to Korean Patent Application Number 10-2013-0123956 filed on Oct. 17, 2013, the entire contents of which application are incorporated herein for all purposes by this reference.

### TECHNICAL FIELD

The present disclosure relates to a head lamp for a vehicle, and more particularly, to a technology of a head lamp for a vehicle using a laser diode as a light source.

### BACKGROUND

A head lamp for a vehicle illuminates the front of the vehicle assisting a driver to view a front field, in which halogen, high intensity discharge (HID), an LED diode, or the like are used as a light source.

However, the halogen, the HID, the LED diode, and the like consume high power, and therefore have low light efficiency. In particular, the overall size of an optical system including the light source and a lens of the halogen, the HID, and the LED diode is large, therefore lowering freedom of design and increasing the weight.

Recently, a head lamp using an environmentally-friendly laser diode as a light source has been developed for long lifespan and high light efficiency.

Referring to FIG. 1, the existing optical system includes a laser diode 1 generating a laser beam within a blue wavelength range. A phosphor 2 reacts to light from the laser diode 1 to output white light. A housing 3 supports the laser diode 1 and the phosphor 2. A reflector 4 reflects the white light outputted from the phosphor 2 forward.

The laser optical system as described above does not emit some of light toward a front side of the phosphor 2 when the light from the laser diode 1 is excited and reacts to the phosphor 2, such that light scattered toward sides and back of the phosphor 2 is present. The existing laser optical system causes a light loss due to the light scattered toward the sides and the back of the phosphor 2, thus reducing the light efficiency.

Further, the reflector 4 of the existing laser optical system is separately disposed outside a laser light source module 5, such that the overall size of the optical size may be increased, the weight and cost may be increased.

The matters described as the related art have been provided only for assisting in the understanding for the background of the present disclosure and should not be considered as corresponding to the related art known to those skilled in the art.

### SUMMARY

An aspect of the present inventive concept provides a head lamp for a vehicle capable of removing light scattered toward sides and a back of a phosphor by reflecting the light scattered toward the sides and the back of the phosphor when light from a laser diode is excited and reacts to the phosphor and allowing the reflected light be incident on the phosphor, thereby reducing light loss and greatly improving light efficiency.

Another aspect of the present inventive concept provides a head lamp for a vehicle which does not include a separate reflector for reflecting white light output from a phosphor forward, thereby reducing the size and weight of an optical system and the overall cost.

According to an exemplary embodiment of the present inventive concept, a head lamp for a vehicle includes a laser light source module. The laser light source module comprises a laser diode generating a laser beam. A phosphor is mounted in front of the laser diode to react to light from the laser diode to output white light. A short wave pass filter is coupled with the phosphor to transmit a laser beam from the laser diode to the phosphor and retro-reflects light scattered in remaining directions of the phosphor avoiding a light emitting surface of the phosphor among the laser beam incident on the phosphor to the phosphor.

The laser light source module may further include a condensing lens disposed between the laser diode and the phosphor to refract the laser beam from the laser diode the phosphor and make the laser beam be incident thereon.

The short wave pass filter may be coupled with the phosphor to cover all surfaces in the remaining directions avoiding the light emitting surface of the phosphor from which the white light is outputted.

The laser light source module may further include a housing fixedly supporting the laser diode, the phosphor, and the condensing lens and preventing the laser beam from the laser diode from being directly exposed exteriorly.

According to another exemplary embodiment of the present inventive concept, a head lamp for a vehicle includes a laser light source module. The laser light source module comprises a laser diode generating a laser beam. A phosphor is mounted in front of the laser diode to react to light from the laser diode to output white light. A short wave pass filter is coupled with the phosphor to transmit a laser beam from the laser diode to the phosphor and retro-reflects light scattered toward a light incident surface of the phosphor among the laser beam incident on the phosphor to the phosphor. A mirror is mounted on the phosphor to cover remaining surfaces of the phosphor other than a light incident surface of the phosphor and a light emitting surface of the phosphor from which the white light is output and make light scattered toward sides of the phosphor among the laser beam incident on the phosphor again be incident on the phosphor.

The laser light source module may further include a condensing lens disposed between the laser diode and the phosphor to refract the laser beam from the laser diode to the phosphor and make the laser beam be incident thereon.

The laser light source module may further include a housing fixedly supporting the laser diode, the phosphor, and the condensing lens and preventing the laser beam from the laser diode from being directly exposed to the outside.

The short wave pass filter may be coupled with the light incident surface of the phosphor on which the laser beam is incident.

The mirror may be mounted on the phosphor to additionally cover a non-transmitting part through which the laser beam is not substantially transmitted among the light incident surface of the phosphor.

The mirror may be coated on the phosphor.

### BRIEF DESCRIPTION OF THE DRAWINGS

The above and other objects, features and advantages of the present disclosure will be more clearly understood from the following detailed description taken in conjunction with the accompanying drawings.

FIG. 1 is a diagram of a laser optical system according to the related art configuring a head lamp.

FIG. 2 is a diagram of a laser light source module configuring a head lamp for a vehicle according to an exemplary embodiment of the present inventive concept.

FIG. 3 is a diagram for describing a phosphor and a short wave pass filter in FIG. 2.

FIGS. 4 and 5 are diagrams illustrating a configuration including a short wave pass filter and a mirror as a laser light source module according to another exemplary embodiment of the present inventive concept.

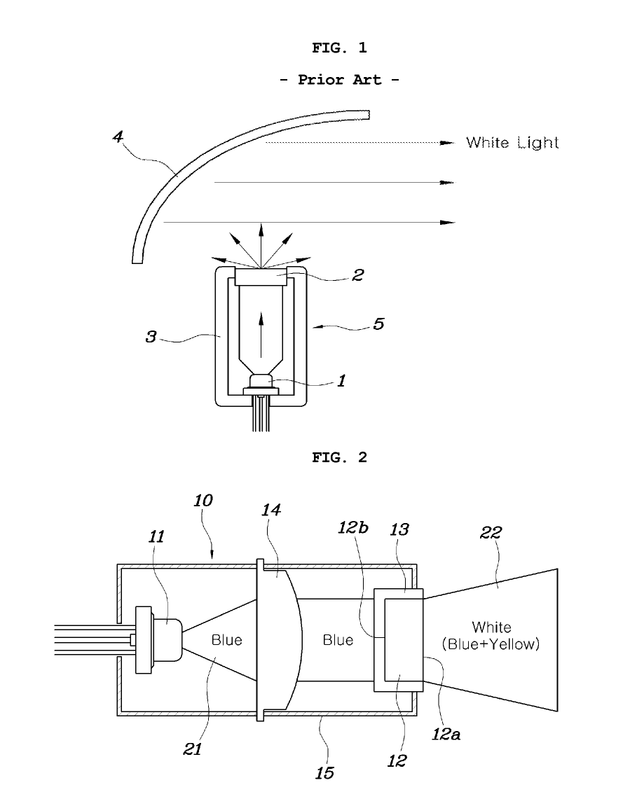

### DETAILED DESCRIPTION

Hereinafter, a head lamp for a vehicle according to exemplary embodiments of the present inventive concept will be described with reference to the accompanying drawings.

Referring to FIGS. 2 and 3, a head lamp for a vehicle according to an exemplary embodiment of the present inventive concept includes a laser light source module 10. The laser light source module 10 includes a laser diode 11 generating a laser beam 21 within the blue wavelength (generally, short wavelength of 450 nm) range. A phosphor 12 is mounted in front of the laser diode 11 and reacts to light from the laser diode 11 to output white light 22. A short wave pass filter 13 is coupled with the phosphor 12 to transmit the laser beam 21 from the laser diode 11 to the phosphor 12 and retro-reflects the light scattered in remaining directions avoiding a light emitting surface 12a of the phosphor 12 among the laser beam 21 incident on the phosphor 12 to the phosphor 12.

Here, the short wave pass filter 13 which transmits light within a short wavelength range and reflects light within a long wavelength range, may be a short wave pass filter (SWPF) or a short pass filter (SPF).

The short wave pass filter 13 is, for example, mainly used in an optical pick-up device such as a compact disc (CD) or a digital versatile disc (DVD) and a technology thereof is disclosed in Korean Patent Publication No. 10-0468961.

The short wave pass filter 13 according to the exemplary embodiment of the present inventive concept transmits the laser beam 21 within a blue wavelength (short wavelength of 450 nm) range generated from the laser diode 11 to the phosphor 12 through a light incident surface 12b.

Further, when the laser beam 21 within the blue wavelength range, which is incident on the phosphor 12, is excited and reacts to the phosphor 12, some of the laser beam is not output forward through a light emitting surface 12a of the phosphor 12 and is scattered toward sides and a back (direction of the light incident surface) of the phosphor 12 other than the light emitting surface 12a. Therefore, the short wave pass filter 13 according to the exemplary embodiment of the present inventive concept retro-reflects the light scattered toward the sides and the back of the phosphor 12 as described above to the phosphor 12.

That is, the short wave pass filter 13 according to the exemplary embodiment of the present inventive concept retro-reflects the laser beam, which is not output forward through the light emitting surface 12a of the phosphor 12 and is scattered in the directions other than the light emitting surface 12a, to the phosphor 12 to greatly reduce a light loss due to the scattered light, thus additionally securing a light quantity and greatly improving light efficiency of the head lamp.

The short wave pass filter 13 according to the exemplary embodiment of the present inventive concept may be coupled with the phosphor 12 to cover all surfaces in the remaining directions avoiding the light emitting surface 12a of the phosphor 12 from which the white light is outputted.

Further, the laser light source module 10 according to the exemplary embodiment of the present inventive concept further includes a condensing lens 14 disposed between the laser diode 11 and the phosphor 12 to refract the laser beam 21 from the laser diode 11 to the phosphor 12 and make the laser beam 21 be incident thereon. A housing 15 fixedly supports the laser diode 11, the phosphor 12, and the condensing lens 14 and prevents the laser beam 21 from the laser diode 11 from being directly exposed to the outside.

In FIG. 3, the dotted line illustrated at the left based on the phosphor 12 is the laser beam 21 within the blue wavelength range of the laser diode 11 which transmits the short wave pass filter 13 and is then incident on a light incident surface 12b of the phosphor 12. The solid line illustrated at the right is white light 22 output forward through the light emitting surface 12a of the phosphor 12 after the laser beam 21 incident on the phosphor 12 reacts to the phosphor 12. A dotted line illustrated at the right is additional white light 23 additionally output forward through the light emitting surface 12a of the phosphor 12 after some of light, which is not output forward through the light emitting surface 12a of the phosphor 12 and is scattered toward the sides and back of the phosphor 12, is retro-reflected to the phosphor 12 due to the short wave pass filter 13 and then reacts to the phosphor 12.

Therefore, the head lamp according to the exemplary embodiment of the present inventive concept may improve the light efficiency of the head lamp as much as the light quantity of the additional white light 23 which is additionally outputted forward through the light emitting surface 12a of the phosphor 12.

Further, the present disclosure uses the laser diode 11 as the light source of the head lamp to more reduce power consumption than the head lamp using the existing halogen, HID, or LED diode as a light source, thereby improving light efficiency, and in particular, may greatly reduce the overall size of an optical system including a light source and a lens, thereby improving freedom of design, reducing weight and cost.

Further, according to the exemplary embodiment of the present inventive concept, the short wave pass filter 13 included in the phosphor 12 outputs the white light 22 forward, and therefore, a reflector needs not to be disposed outside the laser light source module 10 as in the prior art, thereby reducing size and weight of the optical system and saving cost.

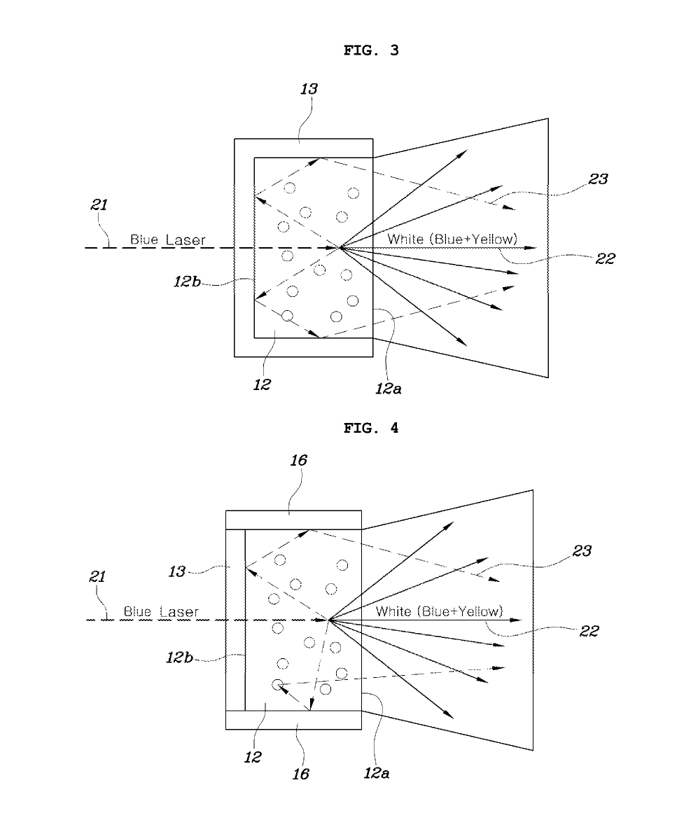

Referring to FIG. 4, the laser light source module 10 according to another exemplary embodiment of the present inventive concept, the short wave pass filter 13 is disposed only on the light incident surface 12b of the phosphor 12 and instead of the short wave pass filter 13, a mirror 16 is mounted on rest surfaces other than the light emitting surface 12a and the light incident surface 12b of the phosphor 12. The mirror 16 is coated and mounted on the phosphor 12 but is not limited thereto.

The configuration of the laser diode 11, the phosphor 12, the condensing lens 14, and the housing 15 is the same as the configuration of the exemplary embodiment of FIG. 2, and therefore, the description thereof will be omitted.

The short wave pass filter 13 retro-reflects the laser beam 21, which is not output forward through the light emitting surface 12a of the phosphor 12 and is scattered toward the back of the phosphor 12 which is the light incident surface 12b of the phosphor 12, to the phosphor 12 to reduce light loss due to light scattered toward the back of the phosphor 12, thereby additionally securing light quantity and improving light efficiency of the head lamp.

The mirror 16 again allows light, which is not output forward through the light emitting surface 12a of the phosphor 12 and is scattered toward the sides of the phosphor 12, to be incident on the phosphor 12 to reduce light loss due to the light scattered toward the sides of the phosphor 12, thereby additionally securing light quantity and improving light efficiency of the head lamp.

The mirror 16 cuts off the scattered light along with the short wave pass filter 13 so as to additionally secure the light quantity but is relatively cheaper than the short wave pass filter 13, and therefore may more save greater cost than the configuration illustrated in FIG. 3, the sides and the back of the phosphor 12 being covered with the short wave pass filter 13.

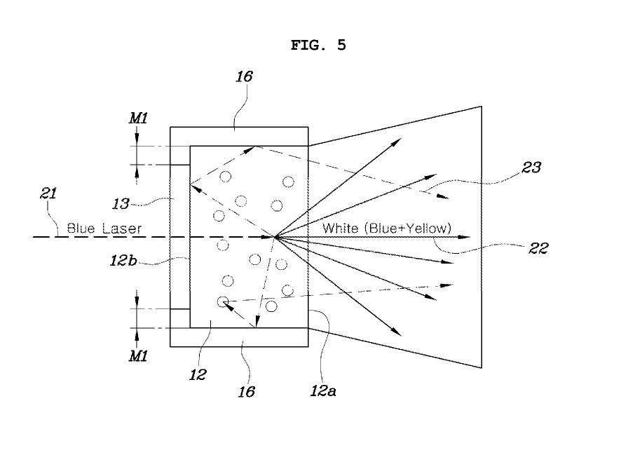

Referring to FIG. 5, according to the exemplary embodiment of the present inventive concept, the mirror 16 may be mounted on the phosphor 12 to additionally cover the sides of the phosphor 12, and if necessary, a non-transmitting part M1 through which the laser beam 21 is not substantially transmitted among the light incident surface 12b of the phosphor 12, thereby more additionally reducing cost.

As described above, according to the exemplary embodiment of the present inventive concept, the laser diode 11 is used as the light source of the head lamp to reduce power consumption of the head lamp, thereby improving light efficiency, and in particular, may greatly reduce the overall size of the optical system including the light source and the lens, thereby improving freedom of design, reducing weight and cost.

Further, according to the exemplary embodiment of the present inventive concept, the short wave pass filter 13 and the mirror 16 of the laser light source module 10 of the head lamp retro-reflect and again allow the light, which is not outputted forward through the light emitting surface 12a of the phosphor 12 and scattered toward the back and the sides of the phosphor 12, to be incident on the phosphor 12 to greatly reduce light loss due to scattered light and additionally secure light quantity, thereby greatly improving light efficiency of the head lamp.

Further, according to the exemplary embodiment of the present inventive concept, the short wave pass filter 13 included in the phosphor 12 outputs the white light 22 forward, and therefore, the reflector need not to be provided outside the laser light source module 10 to output the white light 22 forward, thereby reducing the size of the optical system, reducing weight, and cost.

According to the exemplary embodiments of the present inventive concept, it is possible to improve freedom of design, reduce weight, and save cost by greatly reducing the overall size of the optical system including the light source and the lens by using the laser diode as the light source for the head lamp and secure additional light quantity by retro-reflecting light scattered toward the back and the sides of the phosphor to the phosphor and making the light be incident thereon using the laser light source module of the head lamp and thus greatly improve light efficiency of the head lamp.

Although the present inventive concept has been shown and described with respect to specific exemplary embodiments, it will be obvious to those skilled in the art that the present disclosure may be variously modified and altered without departing from the spirit and scope of the present disclosure as defined by the following claims.

What is claimed is:

1. A head lamp for a vehicle comprising a laser light source module, wherein the laser light source module includes:
a laser diode for generating a laser beam;
a phosphor mounted in front of the laser diode to react to light from the laser diode to output white light; and
a short wave pass filter coupled with the phosphor to transmit the laser beam from the laser diode to the phosphor, the short wave pass filter retro-reflecting light scattered in remaining directions of the phosphor avoiding a light emitting surface of the phosphor among the laser beam incident on the phosphor to the phosphor.

2. The head lamp for a vehicle of claim 1, wherein the laser light source module further includes a condensing lens disposed between the laser diode and the phosphor to refract the laser beam from the laser diode to the phosphor and allow the laser beam be incident on the phosphor.

3. The head lamp for a vehicle of claim 1, wherein the short wave pass filter is coupled with the phosphor to cover all surfaces in the remaining directions avoiding the non-light emitting surface of the phosphor from which the white light is outputted.

4. The head lamp for a vehicle of claim 2, wherein the laser light source module further includes a housing fixedly supporting the laser diode, the phosphor, and the condensing lens and preventing the laser beam from the laser diode from being directly exposed to the outside.

5. The head lamp for a vehicle of claim 1, wherein the laser diode generates the laser beam within a blue wavelength of 450 nm range.

6. The head lamp for a vehicle of claim 1, wherein the short wave pass filter, which is configured to transmit light within a short wavelength range and to reflect the light within a long wavelength range, is the short wave pass filter (SWPF) or a short pass filter (SPF).

7. The head lamp for a vehicle of claim 1, wherein additional white light additionally is outputted forward through the light emitting surface of the phosphor and is retro-reflected to the phosphor due to the short wave pass filter and then reacts to the phosphor.

8. A head lamp for a vehicle comprising a laser light source module, wherein the laser light source module includes:
a laser diode for generating a laser beam;
a phosphor mounted in front of the laser diode to react to light from the laser diode to output white light;
a short wave pass filter coupled with the phosphor to transmit the laser beam from the laser diode to the phosphor, the short wave pass filter retro-reflecting light scattered toward a light incident surface of the phosphor among the laser beam incident on the phosphor to the phosphor; and
a mirror mounted on the phosphor to cover rest surfaces other than the light incident surface of the phosphor and a light emitting surface of the phosphor from which the white light is outputted, the mirror allowing light scattered toward sides of the phosphor among the laser beam incident on the phosphor again be incident on the phosphor.

9. The head lamp for a vehicle of claim 8, wherein the laser light source module further includes a condensing lens disposed between the laser diode and the phosphor to refract the laser beam from the laser diode to the phosphor and allow the laser beam be incident thereon.

10. The head lamp for a vehicle of claim 8, wherein the laser light source module further includes a housing fixedly supporting the laser diode, the phosphor, and the condensing lens and preventing the laser beam from the laser diode from being directly exposed exteriorly.

11. The head lamp for a vehicle of claim 8, wherein the short wave pass filter is coupled with the light incident surface of the phosphor on which the laser beam is incident.

12. The head lamp for a vehicle of claim 8, wherein the mirror is mounted on the phosphor to additionally cover a non-transmitting part through which the laser beam is not substantially transmitted among the light incident surface of the phosphor.

13. The head lamp for a vehicle of claim 8, wherein the mirror is coated on the phosphor.
